(19) United States
(12) Patent Application Publication
(10) Pub. No.: US 2014/0209536 A1
(43) Pub. Date: Jul. 31, 2014

(54) BIOLOGICAL NITROGEN REMOVAL FEED PROCESS

(71) Applicants: Keith Dobie, Humarock, MA (US); Philip B. Pedros, Wakefield, MA (US); Andrew R. McBrearty, Milton, MA (US)

(72) Inventors: Keith Dobie, Humarock, MA (US); Philip B. Pedros, Wakefield, MA (US); Andrew R. McBrearty, Milton, MA (US)

(21) Appl. No.: 13/756,007

(22) Filed: Jan. 31, 2013

(51) Int. Cl. C02F 3/00

(52) U.S. Cl. CPC C02F 3/006
USPC 210/605

(57) ABSTRACT

In a wastewater treatment system comprised of an anoxic tank outputting to a biological reactor and outputting from the reactor to a clear well, a process for controlling the rate and timing of flow through the reactor by means of a floating pump within the anoxic tank. Further enhancement of denitrification is achieved by sending internal recycles into the sludge zone of the anoxic tank via a baffle positioned within the sludge layer.

### CROSS-REFERENCE TO RELATED APPLICATIONS

Applicants claim the priority benefits of U.S. Provisional Patent Application No. 61/592,663, filed Jan. 31, 2012.

### BACKGROUND OF THE INVENTION

This invention relates to waste treatment systems, and in particular, to a method for removing nitrogen from wastewater.

Biological removal of nitrogen from wastewater is a multi-step process and is fairly complex. Nitrogen (in different forms) is a component of many of the molecules present in wastewater. Some examples of nitrogen-based molecules include ammonium, urea and proteins. Removal of nitrogen occurs through biochemical transformations mediated by multiple types of microorganisms, for example ammonification occurs during the oxidation of organic material containing nitrogenous compounds. As soluble organic matter is oxidized nitrogen bound compounds, such as amines (NH₂⁻) are released and bond with H⁺ ions forming ammonia or ammonium.

Removal of the ammonia and ammonium forms of nitrogen from wastewater is a two step process. In the first step the oxidation of ammonium to nitrate (nitrification) is accomplished by the aerobic growth of chemolithotrophic, autotropic bacteria in an aerobic environment. Nitrification occurs only when the quantity of organic carbonaceous matter has been reduced according to the well-established criterion for the transition from oxidation or organics to nitrification, within the biofloc. (See Williamson and McCarty 1976; Owen and Williamson 1976; Riemer 1977; Harremoes 1982; Harremoes and Gonenc 1985).

In the second step organic carbonaceous matter (organics) is oxidized by the growth of heterotrophic bacteria utilizing nitrate as the terminal electron accepter, i.e., denitrification. The nitrate is converted to nitrogen gas (N₂) and released to the atmosphere. The equation describing the biochemical transformation depends on the organic carbon source utilized. The following is the mass based stoichiometric equation, normalized with respect to nitrate, with the influent waste stream as the organic carbon source (Water Environment Federation 1998).

NO₃⁻+0.324C₁₀H₁₉O₃N>0.226 N₂+0.710CO₂+0.087H₂O+0.027NH₃+0.274OH⁻

This results in the removal of nitrogen from the wastewater stream by releasing gaseous nitrogen.

One of the complexities in this process is that, some of the organic matter must be removed before nitrification can occur; however, organic matter is required for denitrification. The inventors have countered this problem in their prior art processes by providing a biological reactor, which grows a biomass on media within the reactor. The reactor is intermittently aerated to create an environment that alternates from aerobic to anoxic. The term, anoxic, means an environment in which respiration with nitrate as the terminal elector is available. The prior art biological reactor processes do not regulate air flow to the reactor. Also, prior art biological reactor processes do not control the flow through the reactor. Flow has been by gravity with a varying pressure head that as a function of the quantity of the internal recycle.

### SUMMARY OF THE INVENTION

Prior art wastewater treatment systems basically comprised of an anoxic tank outputting to a biological reactor and outputting from the reactor to a clear well are known. The present invention provides a major improvement to prior art wastewater treatment systems by controlling the rate and timing of flow through the biological reactor using a programmable logic controller (PLC) controlled valve or pump. This permits operators to insure that all liquid passing through the reactor is subjected to both aerobic and anoxic periods before passing through the reactor to a clear well. This allows for the residence time within the anoxic tank containing carbon from sludge digestion, to be controlled so as to improve denitrification and flow to the reactor at the appropriate time. By controlling the flow to the reactor and manipulating the addition of air and wastewater, applicants have greatly improved nitrogen removal when compared to the uncontrolled gravity flow.

Currently, biological reactor recycle streams are returned to the settle zone of the anoxic tank. Recycling brings nitrified wastewater into contact with carbonaceous wastewater in a low dissolved oxygen environment. Further enhancement of denitrification is achieved by sending the internal recycles into the sludge zone of the anoxic tank where there is more carbon and less oxygen than in the settled zone. Agitation and suspension of the sludge is reduced by the use of a baffle which distributes the recycle flow within the sludge layer. Any undesirable suspension is mitigated by control of the flow which allows the sludge to resettle before flow is allowed to flow to the reactor. Thus, only settled wastewater flows to the reactor.

Two different environments are required for nitrification and denitrification: an aerobic environment for nitrification and an anoxic environment for denitrification. These environments can be maintained within the present invention process. However, the wastewater must be delivered to the invention process so that optimal conditions exist to maximize the removal of nitrogen and eliminate or reduce the need for a supplemental electron donor.

These together with other objects of the invention, along with various features of novelty, which characterize the invention, are pointed out with particularity in this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 is a block diagram of the present invention biological nitrogen removal feed process.

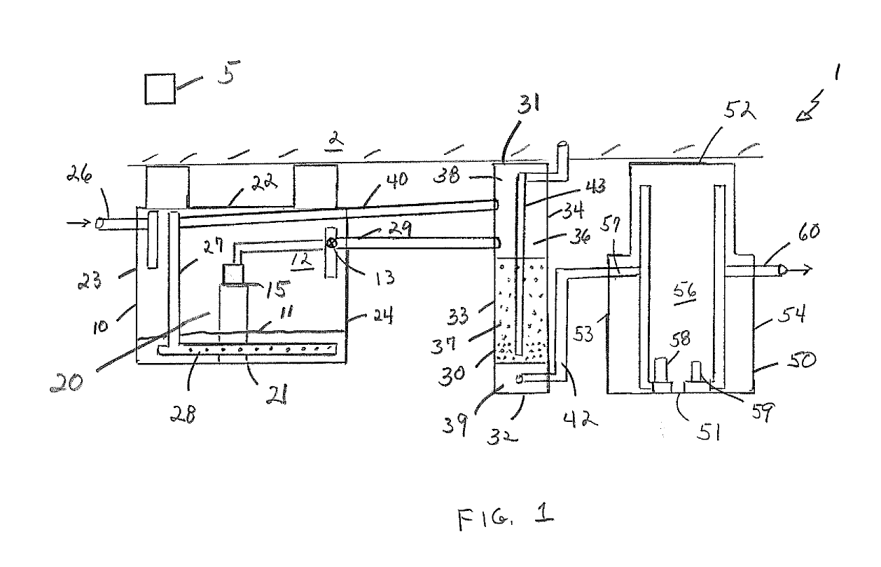

### DETAILED DESCRIPTION OF INVENTION

Referring to the drawings in detail wherein like elements are indicated by like numerals, there are shown a process flow for a typical wastewater treatment system 1, and the invention process installed in the anoxic tank portion of the wastewater treatment system 1.

The wastewater treatment system 1 has an anoxic tank 10 outputting to a biological reactor 30 and outputting from the reactor to a clear well 50. The anoxic tank 10, often a septic tank, typically provides primary treatment for wastewater. The anoxic tank 10 has a bottom 21, top 22, an input wall 23, an output wall 24 and two side walls 25 interconnecting the input and out put walls, said bottom, top, input wall, output wall and side walls defining an anoxic tank interior 20. The anoxic tank input 23 has a raw wastewater input pipe 26 connecting an external raw wastewater source with the anoxic tank interior 20. The input pipe 26 is located near to the anoxic tank top 22. The anoxic tank output wall has an output pipe 29 for anoxic tank effluent 12. Unlike prior art wastewater treatment systems, the present invention does not operate from anoxic tank to biological reactor via gravity flow. Rather, a “floating” pump 15 is placed within the anoxic tank interior whereby flow from the anoxic tank 10 to the biological reactor 30 is controlled.

The biological reactor 30 has a top 31, a bottom 32, receiving side 33, discharge side 34, two opposite side walls 35 interconnecting the receiving and discharge sides, said top, bottom, receiving side, discharge side and side walls defining a reactor interior 36. The reactor interior 36 has a filter 37, an open head-space 38 above the filter, and a sump 39 formed beneath the filter and reactor bottom 32. The anoxic tank output pipe 29 connects to the biological reactor 30 and the anoxic tank effluent 12 is pumped by the floating pump 15 to the biological reactor interior head-space 38 just above the reactor filter 37. The biological reactor 30 has a backwash/recycle pipe 40 interconnecting the biological reactor interior head space 38 with a hollow vertical recycle pipe 27 located in the anoxic tank interior near to the anoxic tank input wall 23. The anoxic tank vertical recycle pipe 27 is fluidly connected to an elongated baffle 28 comprised of perforated horizontal pipe 28 positioned adjacent the anoxic tank interior bottom 21 extending centrally from the vertical recycle pipe 27 toward the anoxic tank output wall 24.

The biological reactor 30 has a discharge pipe 42 interconnecting the biological reactor sump 39 with a clear well interior 56. The clear well 50 is comprised of a bottom 51, a top 52, a receiving side 53, a discharge side 54, and two side walls interconnecting said receiving and discharge sides 55, said bottom, top, receiving side, discharge side and side walls defining a clear well interior 56. The biological reactor discharge pipe 42 connects to the clear well inlet pipe 57 in the clear well receiving side 53 providing a channel for the biological reactor treated wastewater into the clear well interior 56. The clear well interior 56 contains a first pump 58 on the clear well bottom 51, said first pump being connected to said clear well inlet pipe 57, and being adapted to provide reverse flow from the clear well interior 56 back through the biological reactor interior 36. The clear well interior 56 also contains a second pump 59 on the clear well bottom 51, said second pump being interconnected to a clear well discharge outlet 60 in the clear well discharge side 54, said second pump 60 adapted to discharge the contents of said clear well interior 56 out through said discharge outlet 60.

Raw untreated sewage wastewater having a significant concentration of waste solids is introduced into the anoxic tank interior 20 through the anoxic tank input pipe 26. Solids having a higher density than liquid sink to the tank bottom 21 to form a sludge layer 11. The elongated baffle 28 is in the sludge layer 11. The liquid portion of the wastewater, which exits the anoxic tank discharge end 24 by means of gravity, a pump, or a siphon, is the anoxic tank effluent 12. The anoxic tank effluent 12 is brought into the biological reactor 30 for treatment in an aerobic environment causing bacteria to oxidize the ammonia nitrogen to nitrate nitrogen, a process known as nitrification. By then treating the effluent in an anoxic environment, the nitrified wastewater is denitrified and the nitrogen gas formed is released to the atmosphere while the treated wastewater, with a reduced level of nitrogen compounds, is returned to the receiving stream or to the clear well 50.

The invention process enhances a typical prior art biological nitrogen removal feed process through the use of two mechanisms: a return of nitrified wastewater into the sludge layer 11 of an anoxic tank 10, and through the use of the present invention feed process.

The return of nitrified wastewater via the reactor recycle pipe 40, the anoxic tank vertical recycle pipe and baffle 28, into the sludge layer 11 is significant because it allows the system to release unused carbon for denitrification. The return to the sludge layer consists of returning liquid from the reactor head-space via the recycle pipe 40 into the anoxic tank vertical pipe 27 and baffle 28 for discharge into the sludge layer 11. In order to avoid carryover to the biological reactor 30 of sludge particulate matter which is disturbed during the return, the wastewater is held in the anoxic tank interior 20 for a fixed time. The floating pump 15 is turned off for a period of time to allow the sludge to settle and prevent sludge from moving forward into the biological reactor 30 before it settles in the anoxic tank interior 20. This allows sludge settling before the floating pump 15 is reactivated moving the anoxic tank effluent forward. In an alternate embodiment a remotely controlled check valve 13 may be placed in the anoxic tank output pipe 29 to prevent sludge-filled effluent from moving toward the biological reactor for a period of time.

The present invention feed process is comprised of the following sub-cycles: (a) dose cycle, (b) rest cycle, (c) bump cycle, (d) rest cycle, (e) aeration cycle, and (f) rest cycle.

During the dose cycle, a measured volume of wastewater (Dose) is delivered from the anoxic tank interior 20 to the biological reactor 30 via the anoxic tank output pipe 29. The Dose is calculated as the volume of liquid required to displace approximately half of the liquid in the reactor filter media 37. Delivery may be controlled by a PLC 5 using the floating pump 15 or check valve 13. The PLC controls how long the feed pump 15 runs or how long the valve 13 is opened. The Dose enters the biological reactor interior 36 and displaces treated wastewater to the clear well 50.

A Dose rest period is then entered. The rest period allows time for the delivered Dose to be denitrified. The Dose liquid received by the biological reactor is ideal for denitrification because it contains nitrates, carbon and a very low dissolved oxygen. The time period of the Dose rest period is a defined value.

After the Dose rest period, a Bump cycle is entered. During the Bump cycle, nitrified and oxygenated wastewater is returned to the biological reactor 30 from the clear well 50 using the clear well first pump 58, through the clear well inlet pipe 57, back through the biological reactor discharge pipe 42, into the biological reactor sump 39, up into the filter media 37, and mixed with the Dose that was put into the reactor during the dose cycle. Following the Bump cycle, a Bump rest period is entered. The Bump rest period allows time for the removal of carbon introduced by the Dose cycle.

After the Bump rest period, an aeration cycle is entered. During the aeration cycle, oxygen is provided to the biological reactor interior 36 via an air pipe 43 inserted into the biological reactor interior 36 near to the reactor top 31, through the filter media 37. The air pipe 43 is connected to an air source, such as an air pump and/or blower (not shown), on the ground surface 2. During the aeration cycle, air is provided into the air pipe 43 to the reactor bottom 37 and 39. Oxygenation is provided to the biological reactor interior 36 while air is being blown into the air pipe 43. The blower “on” time is recomputed at regular intervals by the PLC and is based on the volume and constituent load of influent wastewater sensed by the system during the previous time interval.

Following the aeration cycle, the air blower is shut off and an aeration rest period is entered. The aeration rest period allows time for nitrification. This rest period is a value that is variable and may be modified to optimize treatment of wastewater. At the end of the aeration rest period, a Dose cycle will begin.

It is understood that the above-described embodiment is merely illustrative of the application. Other embodiments may be readily devised by those skilled in the art which will embody the principles of the invention and fall within the spirit and scope thereof.

We claim:

1. A wastewater treatment process for a wastewater treatment system having an anoxic tank outputting to a biological reactor and outputting from the reactor to a clear well, said anoxic tank having a bottom, top, an input wall, an output wall and two side walls interconnecting the input and out put walls, said bottom, top, input wall, output wall and side walls defining an anoxic tank interior, said anoxic tank input wall having a raw wastewater input pipe connecting an external raw wastewater source with the anoxic tank interior, said wastewater input pipe being located near to the anoxic tank top, said anoxic tank output wall having an output pipe for anoxic tank effluent, said anoxic tank interior having a progammable logic controlled floating pump placed within controlling anoxic tank effluent flow out of said anoxic tank interior, said biological reactor having a top, a bottom, receiving side, discharge side, two opposite side walls interconnecting the receiving and discharge sides, said top, bottom, receiving side, discharge side and side walls defining a reactor interior, said biological reactor interior having a filter, an open head-space above the filter, and a sump formed beneath the filter and above reactor bottom, said anoxic tank output pipe connecting to the biological reactor whereby the anoxic tank effluent is adapted to being pumped by the floating pump to the biological reactor interior head-space just above the reactor filter, said biological reactor having a discharge pipe interconnecting the biological reactor sump with a clear well interior, said clear well comprised of a bottom, a top, a receiving side, a discharge side, and two side walls interconnecting said receiving and discharge sides, said bottom, top, receiving side, discharge side and side walls defining said clear well interior, said biological reactor discharge pipe connect to the clear well inlet pipe in the clear well receiving side providing a channel for the biological reactor treated wastewater into the clear well interior, said clear well interior contains a first pump on the clear well bottom, said first pump being connected to said clear well inlet pipe, and being adapted to provide reverse flow from the clear well interior back through the biological reactor interior, said clear well interior also containing a second pump on the clear well bottom, said second pump being interconnected to a clear well discharge outlet in the clear well discharge side, said second pump adapted to discharge the contents of said clear well interior out through said discharge outlet, said process comprising the steps of:
providing a backwash/recycle pipe interconnecting the biological reactor interior head space with a hollow vertical recycle pipe located in the anoxic tank interior near to the anoxic tank input wall, said anoxic tank vertical recycle pipe fluidly connected to an elongated baffle comprised of perforated horizontal pipe positioned adjacent the anoxic tank interior bottom extending centrally from the vertical recycle pipe toward the anoxic tank output wall;
introducing raw untreated sewage wastewater having a significant concentration of waste solids into the anoxic tank interior through the anoxic tank input pipe, said solids having a higher density than said sewage wastewater sinking to the tank bottom to form a sludge layer about said elongated baffle;
pumping the liquid portion of the wastewater, known as anoxic tank effluent, through the anoxic tank discharge end into the biological reactor for nitrification;
releasing nitrogen gas formed to the atmosphere;
passing treated wastewater, now nitrified wastewater, to the clear well;
return a portion of the nitrified wastewater from the reactor head space via the reactor recycle pipe, the anoxic tank vertical recycle pipe and baffle, into the sludge layer;
turning off the floating pump for a fixed time to allow the sludge to settle and prevent sludge from moving forward into the biological reactor before it settles in the anoxic tank interior.

2. A wastewater treatment process as recited in claim 1, further comprising steps:
entering a dose cycle wherein a measured volume of wastewater (dose) is delivered from the anoxic tank interior to the biological reactor via the anoxic tank output pipe, said dose entering the biological reactor interior displacing treated wastewater to the clear well;
entering a dose rest period defined by a selected value allowing time for the delivered dose to be denitrified.
entering a bump cycle wherein nitrified and oxygenated wastewater is returned to the biological reactor from the clear well using the clear well first pump, through the clear well inlet pipe back through the biological reactor discharge pipe , into the biological reactor sump, up into the filter media, and mixed with the dose that was put into the reactor during the dose cycle.
entering a bump rest period allowing time for the removal of carbon introduced by the dose cycle;
entering an aeration cycle wherein oxygen is provided to the biological reactor interior via an air pipe inserted into the biological reactor interior ear to the reactor top, through the filter media near to the biological reactor bottom;
entering an aeration rest period wherein oxygen provided via the air pipe is shut off;
repeating the above steps beginning with the dose cycle.

3. A wastewater treatment process as recited in claim 2, wherein:
the dose is calculated as the volume of liquid to displace approximately half of the liquid in the reactor filter media wherein delivery of said dose is controlled by the floating pump.

4. A wastewater treatment process as recited in claim 3, wherein:
the air pipe is connected to an air source, such as an air pump and/or blower, on a ground surface.
